(19) United States
(12) Patent Application Publication
(10) Pub. No.: US 2024/0281985 A1
(43) Pub. Date: Aug. 22, 2024

(54) Method for Operating a Gated Camera, Control Device for Carrying Out Such a Method, Viewing Range Measurement Device Having Such a Control Device, and Motor Vehicle Having Such a Viewing Range Measurement Device

(71) Applicant: Daimler Truck AG, Leinfelden-Echterdingen (DE)

(72) Inventor: Fridtjof STEIN, Ostfildern (DE)

(21) Appl. No.: 18/567,744

(22) PCT Filed: Jun. 3, 2022
(86) PCT No.: PCT/EP2022/065218

§ 371 Date: Dec. 6, 2023

(30) Foreign Application Priority Data
Jun. 7, 2021 (DE) 10 2021 002 915.1

(51) Int. Cl. G06T 7/30; G06T 7/00; G06T 7/215

(52) U.S. Cl. CPC G06T 7/30; G06T 7/001; G06T 7/215

(57) ABSTRACT

A method for operating a gated camera which has a lighting device and an optical sensor. An actuation of the lighting device and optical sensor are chronologically first coordinated with each other and a visible object region is assigned to the first coordinated actuation. Via the first coordinated actuation, recording a first recording of the visible object region from a first distance between the gated camera and the visible object region. A second coordinated actuation is selected such that the visible object region is assigned to the second coordinated actuation. Via the second coordinated actuation, recording a second recording of the visible object region from a second distance between the gated camera and the visible object region. The first recording and the second recording are compared using a criterion and a viewing range of the gated camera is inferred on a basis of the comparing.

### BACKGROUND AND SUMMARY OF THE INVENTION

The invention relates to a method for operating a gated camera, to a control device for carrying out such a method, to a viewing range measurement device having such a control device and to a motor vehicle having such a viewing range measurement device.

Methods are known for calculating a viewing range, in which a contrast or a spectrum of a recording is evaluated. In particular, methods are known in which a decreasing contrast of a lane marking is evaluated with increasing distance. A disadvantage of the known methods is that atmospheric reflections have a large influence on the contrast and/or the spectrum of the recording—at night in particular, particles along the viewing rays generate significant reflections via diffusion—and the calculation of the viewing range is thus very prone to error.

The object of the invention is to create a method for operating a gated camera, a control device for carrying out such a method, a viewing range measurement device having such a control device, and a motor vehicle having such a viewing range measurement device, wherein the specified disadvantages are at least partially alleviated, preferably avoided.

The object is in particular solved by creating a method for operating a gated camera, which has a lighting device and an optical sensor, wherein an actuation of the lighting device and of the optical sensor are chronologically coordinated with each other. A visible object region is assigned to a first coordinated actuation, wherein a first recording of the visible object region is recorded from a first distance between the gated camera and the visible object region by means of the first actuation. A second coordinated actuation is selected such that the visible object region is assigned to the second coordinated actuation, wherein by means of the second coordinated actuation, a second recording, chronologically after the first recording, of the visible object region is recorded from a second distance, which is different from the first distance, between the gated camera and the visible object region. The first recording and the second recording are compared using at least one criterion, wherein a viewing range of the gated camera is inferred on the basis of the comparison.

Advantageously, the gated camera fades out reflections that arise due to atmospheric disturbances outside of the visible object region, such that these reflections cannot be seen in the first recording and/or in the second recording. The atmospheric disturbances preferably attenuate the light of the lighting device coming back to the optical sensor depending on the first distance and on the second distance, such that a viewing range of the gated camera can advantageously be inferred. In addition, on the basis of this method, the viewing range of the gated camera can advantageously be determined, up to which a precise, robust and/or minimally error-prone object recognition and/or object measurement is possible.

The method for generating recordings by means of an actuation of a lighting device and of an optical sensor which are chronologically coordinated with each other, is in particular a method known as a gated imaging method; in particular, the optical sensor is a camera, which is only sensitively operated in a particular, limited period of time, which is referred to as “gated control”. The lighting device too is correspondingly only actuated chronologically in a particular, selected period of time in order to light up a scene on the object side, in particular the visible object region.

In particular, a pre-defined number of light pulses is emitted by the lighting device, preferably having a duration between 5 ns and 20 ns. The beginning and the end of the exposure of the optical sensor is coupled with the number and the duration of the emitted light pulse and a start of the lighting. As a result, a particular visible object region can be detected by the optical sensor by the chronological actuation of the lighting device, on the one hand, and of the optical sensor, on the other hand, with a correspondingly defined spatial position, i.e., in particular at particular distances of a near and of a far limit of the visible object region from the optical sensor. A spatial position of the optical sensor and of the lighting device is known from the structure of the gated camera. Preferably, a spatial distance between the lighting device and the optical sensor is additionally known, and is small in comparison with the distance between the lighting device or the optical sensor and the visible object region. In the context of the present technical teaching, a distance between the optical sensor and the visible object region is thus the same as a distance between the gated camera and the visible object region.

The visible object region is thus the region—on the object side—in three-dimensional space which is imaged by means of the optical sensor in a two-dimensional recording on an image plane of the optical sensor due to the number and the duration of the light pulses of the lighting device and the start of the lighting in connection with the start and the end of the exposure of the optical sensor.

When the term “on the object side” is used here and in the following, a region in actual space is meant. When the term “on the image side” is used here and in the following, a region on the image plane of the optical sensor is meant. The visible object region is given in this case on the object side. This corresponds to a region on the image side on the image plane assigned by the laws of imaging and by the chronological actuation of the lighting device and of the optical sensor.

Depending on the start and the end of the exposure of the optical sensor, light pulse photons hit the optical sensor after the lighting by the lighting device begins. The further away the visible object region is from the lighting device and the optical sensor, the longer the chronological duration until a photon which is reflected in this object region hits the optical sensor. The chronological distance between an end of the lighting and a beginning of the exposure increases the further the visible object region is from the lighting device and from the optical sensor.

According to one embodiment of the method, it is thus in particular possible to define the position and the spatial width of the visible object region, in particular a distance between the near limit and the far limit of the visible object region, by a correspondingly suitable choice of the chronological actuation of the lighting device, on the one hand, and of the optical sensor, on the other hand.

In a preferred embodiment of the method, the visible object region is pre-determined, wherein the chronological coordination of the lighting device, on the one hand, and of the optical sensor, on the other hand, is correspondingly pre-determined.

In a preferred embodiment, the lighting device has at least one surface emitter, in particular a so-called VCSE laser. As an alternative or in addition, the optical sensor is preferably a camera.

In the context of the present technical teaching, the first distance between the gated camera and the visible object region and the second distance between the gated camera and the visible object region are respectively distances between the gated camera and the near limit of the visible object region.

In the context of the present technical teaching, the visible object region is preferably fixedly arranged in a coordinate system, wherein the gated camera is variably arranged in the coordinate system—in particular at two different positions.

Preferably, an empty, in particular static road surface is used as a visible object region, wherein the visible object region additionally preferably has an edge construction and/or edge vegetation.

In particular, an object which is exclusively located in the visible object region at the point in time of only one recording, selected from the first recording and the second recording, has a disadvantageous effect on the measurement of the viewing range.

In a preferred embodiment, the gated camera is displaced in particular with a constant speed relative to the visible object region. In this case, a difference between the first distance and the second distance can be calculated from the speed with which the gated camera is displaced and a length of time between when the first recording is recorded and the second recording is recorded. Preferably, the length of time is selected to be short if at least one object, in particular an object which is moving or moves, is present in the visible object region.

According to a development of the invention, it is provided that the first recording and the second recording are in particular aligned with each other by means of an image registration method before the comparison. As an alternative or in addition, in at least one recording, selected from the first recording and the second recording, at least one moving object or motion artefact is removed.

Advantageously, by means of the image registration method, the gated camera's own movement, in particular a height change and/or a change of the roll pitch yaw angles, can be compensated for.

Motion artefacts and/or moving objects, which can in particular only be seen in the first recording or the second recording, influence the comparability of the two recordings. The comparability of the two recordings can thus advantageously be increased by removing the at least one moving object or motion artefact.

According to a development of the invention, it is provided that, as a comparison, a difference recording is generated as a difference between the first recording and the second recording, wherein the difference recording is evaluated using the at least one criterion.

According to a development of the method, it is provided that an attenuation of a luminance—in particular in a ratio to a difference from the first distance between the gated camera and the visible object region and the second distance between the gated camera and the visible object region—is used as the at least one criterion. Advantageously, a viewing range of the gated camera can be easily and/or robustly inferred by means of the attenuation of the luminance.

Preferably, the attenuation of the luminance is determined using the difference recording. Advantageously, the attenuation of the luminance can thus be determined very precisely and reliably.

According to a development of the invention, it is provided that the viewing range of the gated camera is calculated by means of the attenuation of the luminance—in particular in the ratio to the difference from the first distance between the gated camera and the visible object region and the second distance between the gated camera and the visible object region—and a pre-determined threshold luminance.

Advantageously, the luminance of a recording is greater, the smaller the distance is between the gated camera, in particular of the optical sensor, and the visible object region, in particular the near limit of the visible object region. A change in the luminance from the first recording to the second recording is thus always negative. The viewing range, at which in particular the pre-determined threshold luminance is present, can thus be at least approximately calculated with one of the two following formulae:

$${S}_{w} = {S}_{2} + {S}_{ob} + \frac{{Ld}_{sw} - {Ld}_{2}}{{\partial }_{S} Ld} \qquad ( 1 )$$

$${S}_{w} = {S}_{1} + {S}_{ob} + \frac{{Ld}_{sw} - {Ld}_{1}}{{\partial }_{S} Ld} \qquad ( 2 )$$

The viewing range S_{w}, the first distance S₁, the second distance S₂, a distance S_{ob} between the near and the far limit of the visible object region, the luminance of the first recording Ld₁, the luminance of the second recording Ld₂, the threshold luminance Ld_{sw} and the change of the luminance as a function of the distances ∂sLd is used, wherein the change of the luminance as a function of the distances is calculated by means of the formula:

$${\partial }_{S} Ld = \frac{{Ld}_{2} - {Ld}_{1}}{{S}_{2} - {S}_{1}} \qquad ( 3 )$$

According to a development of the invention, it is provided that on the basis of the viewing range of the gated camera, a maximum speed for a motor vehicle having the gated camera is determined. Advantageously, the maximum speed for the motor vehicle having the gated camera, which is in particular an autonomous motor vehicle, is set such that the viewing range is greater than a braking distance assigned to the maximum speed of the motor vehicle. It is thus advantageously possible that the motor vehicle, which is in particular autonomous, can be reliably operated even in adverse atmospheric conditions.

According to a development of the invention, it is provided that the viewing range of the gated camera is transmitted by means of a communication device. It is thus advantageously possible that the motor vehicle having the gated camera shares the determined viewing range with other motor vehicles. As an alternative or in addition, it is possible to transmit the viewing range to a computer center.

In a preferred embodiment, a method according to the invention or a method according to one or more of the previously described embodiments is carried out cyclically—in particular at regular chronological intervals. The viewing range is thus advantageously determined depending on the situation, and an adaptive adjustment of the maximum speed of the motor vehicle is thus possible.

The object is also solved by creating a control device, which is equipped to carry out a method according to the invention or a method according to one or more of the previously described embodiments. The control device is preferably designed as a computer device, particularly preferably as a computer, or as a control unit, in particular as a control unit of a motor vehicle. In connection with the control device, the advantages in particular result which have already been explained in connection with the method.

The control device is preferably equipped to be operatively connected to the gated camera, in particular to the lighting device and the optical sensor, and is equipped for their respective actuation. In addition, the control device is preferably equipped to be operatively connected to the communication device, and is equipped for its actuation.

The object is also solved by creating a viewing range measurement device, which has a gated camera that has a lighting device and an optical sensor, and which has a control device according to the invention or a control device according to one or several of the previously described embodiments. In connection with the viewing range measurement device, the advantages in particular result which have already been explained in connection with the method and the control device.

In a preferred embodiment, the viewing range measurement device additionally has a communication device, which is equipped to transmit a viewing range of the gated camera.

The control device is preferably operatively connected to the gated camera, in particular to the lighting device and the optical sensor, and is equipped for their respective actuation. In addition, the control device is preferably operatively connected to the communication device, and is equipped for its actuation.

The object is also solved by creating a motor vehicle having a viewing range measurement device according to the invention or a viewing range measurement device according to one or more of the previously described exemplary embodiments. In connection with the motor vehicle, the advantages in particular result which have already been explained in connection with the method and the control device.

In a preferred embodiment, the motor vehicle is designed as an autonomous motor vehicle. As an alternative or in addition, the motor vehicle is preferably designed as a heavy goods vehicle. It is possible, however, that the motor vehicle is designed as a passenger car, a utility vehicle or another motor vehicle.

The invention is explained in more detail in the following with reference to the drawings.

### BRIEF DESCRIPTION OF THE DRAWINGS

FIG. 1 shows a schematic depiction of an exemplary embodiment of a motor vehicle and of a visible object region at the point in time at which a first recording is recorded;

FIG. 2 shows a schematic depiction of the exemplary embodiment of the motor vehicle and of the visible object region at the point in time at which a second recording is recorded; and

FIG. 3 shows a schematic depiction of a flow chart of an exemplary embodiment of a method for operating a gated camera.

### DETAILED DESCRIPTION OF THE DRAWINGS

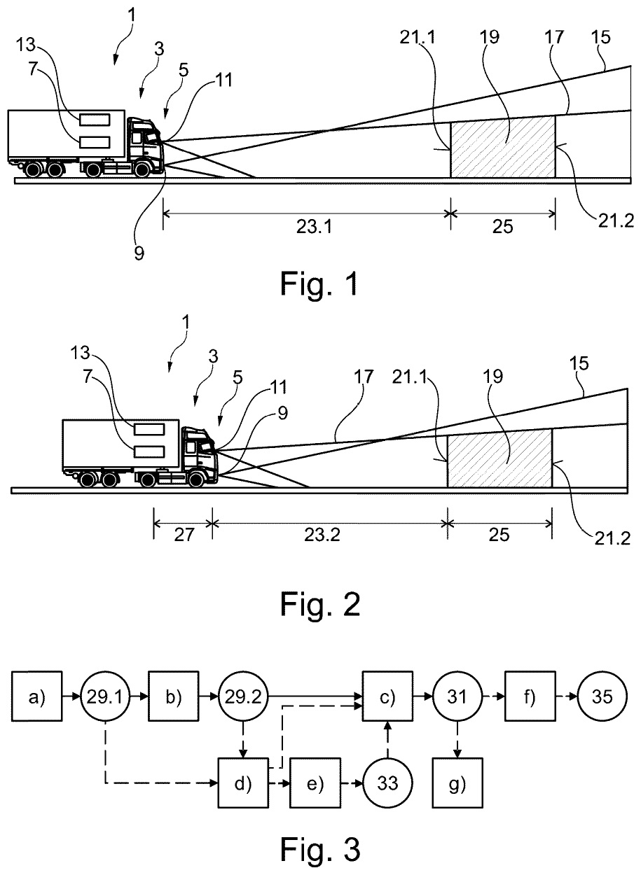

FIG. 1 shows a schematic depiction of an exemplary embodiment of a motor vehicle 1 having a viewing range measurement device 3 at the point in time at which a first recording 29.1 is recorded. The viewing range measurement device 3 has a gated camera 5 and a control device 7. The gated camera 5 further has a lighting device 9—preferably a laser, in particular a VSCE laser—and an optical sensor 11—preferably a camera. In addition, the viewing range measurement device 3 preferably has a communication device 13. The control device 7 is here only schematically depicted, and is connected in a manner which is not explicitly depicted to the gated camera 5, in particular to the lighting device 9 and the optical sensor 11, and is equipped for their respective actuation. In addition, the control device 7 is preferably connected in a manner which is not explicitly depicted to the communication device 13, and is equipped for its actuation. In FIG. 1, a lighting frustum 15 of the lighting device 9 and an observation region 17 of the optical sensor 11 are in particular depicted.

A visible object region 19, which results as a subset of the lighting frustum 15 of the lighting device 9 and the observation region 17 of the optical sensor 11, is additionally depicted via cross-hatching. The visible object region 19 has a near limit 21.1 and a far limit 21.2. The visible object region 19, in particular the near limit 21.1, has a first distance 23.1 from the gated camera 5, in particular from the optical sensor 11. The near limit 21.1 and the far limit 21.2 further have a separation 25.

FIG. 2 shows a schematic depiction of the exemplary embodiment of the motor vehicle 1 and of the visible object region 19 at the point in time at which a second recording 29.2 which chronologically follows the first recording 29.1 is recorded.

Identical and functionally identical elements are provided with the same reference signs in all figures, such that reference is made to the previous description in this respect.

In the period of time between the point in time at which the first recording 29.1 is recorded and the point in time at which the second recording 29.2 is recorded, the motor vehicle 1 has moved by a stretch 27 in the direction of the visible object region 19. The visible object region 19, in particular the near limit 21.1, thus has a second distance 23.2 from the gated camera 5, in particular from the optical sensor 11. The near limit 21.1 and the far limit 21.2 further have the separation 25.

The control device 7 is in particular equipped to carry out a method for operating the gated camera 5 and to determine a viewing range of the gated camera 5.

FIG. 3 shows a schematic depiction of a flow chart of an exemplary embodiment of the method for operating the gated camera 5.

Actuation of the lighting device 9 and of the optical sensor 11 are chronologically coordinated with each other.

In a first step a), the visible object region 19 is assigned to a first coordinated actuation. Furthermore, by means of the first coordinated actuation, the first recording 29.1 of the visible object region 19 is recorded from the first distance 23.1 between the gated camera 5 and the visible object region 19.

In a second step b), a second coordinated actuation is selected such that the visible object region 19 is assigned to the second coordinated actuation. Furthermore, by means of the second coordinated actuation, a second recording 29.2, chronologically after the first recording 29.1, of the visible object region 19 is recorded from a second distance 23.2, which is different from the first distance 23.1, between the gated camera 5 and the visible object region 19.

In a third step c), the first recording 29.1 and the second recording 29.2 are compared using at least one criterion, wherein a viewing range 31 of the gated camera 5 is inferred on the basis of the comparison.

Preferably, an attenuation of a luminance—in particular in a ratio to a difference from the first distance 23.1 between the gated camera 5 and the visible object region 19 and the second distance 23.2 between the gated camera 5 and the visible object region 19—is used as the at least one criterion.

Preferably, by means of the attenuation of the luminance—in particular in the ratio to the difference from the first distance 23.1 between the gated camera 5 and the visible object region 19 and the second distance 23.2 between the gated camera 5 and the visible object region 19—and a pre-determined threshold luminance, the viewing range 31 of the gated camera 5 is calculated.

In an optional fourth step d), the first recording 29.1 and the second recording 29.2 are preferably aligned with each other, in particular before the comparison in the third step c), by means of an image registration method. As an alternative or in addition, in at least one recording 29, selected from the first recording 29.1 and the second recording 29.2, at least one moving object or motion artefact is preferably removed.

In an optional fifth step e), a difference recording 33 as a difference between the first recording 29.1 and the second recording 29.2 is preferably generated as a comparison—in particular before the comparison in the third step c). Preferably, in the third step c), the difference recording 33 is then evaluated by means of the at least one criterion.

In an optional sixth step f), preferably on the basis of the viewing range 31 of the gated camera 5, a maximum speed 35 for a motor vehicle 1 having the gated camera 5 is determined.

In an optional seventh step g), the viewing range 31 of the gated camera 5 is preferably transmitted by means of the communication device 13. In particular, the viewing range 31 of the gated camera 5 is transmitted to a computer center and/or at least one further motor vehicle by means of the communication device 13.

1.-10. (canceled)

11. A method for operating a gated camera (5) which has a lighting device (9) and an optical sensor (7), comprising the steps of:
an actuation of the lighting device (9) and of the optical sensor (7) are chronologically first coordinated with each other;
assigning a visible object region (19) to the first coordinated actuation;
via the first coordinated actuation, recording a first recording (29.1) of the visible object region (19) from a first distance (23.1) between the gated camera (5) and the visible object region (19);
a second coordinated actuation is selected such that the visible object region (19) is assigned to the second coordinated actuation;
via the second coordinated actuation, recording a second recording (29.2), chronologically after the first recording (29.1), of the visible object region (19) from a second distance (23.2), which is different from the first distance (23.1), between the gated camera (5) and the visible object region (19);
comparing the first recording (29.1) and the second recording (29.2) using at least one criterion; and
inferring a viewing range (31) of the gated camera (5) on a basis of the comparing.

12. The method according to claim 11, wherein the first recording (29.1) and the second recording (29.2) are aligned with each other before the comparing by an image registration method and/or wherein in at least one recording (29), selected from the first recording (29.1) and the second recording (29.2), at least one moving object or motion artefact is removed.

13. The method according to claim 11, wherein, as a comparison, a difference recording (33) is generated as a difference between the first recording (29.1) and the second recording (29.2) and wherein the difference recording is evaluated using the at least one criterion.

14. The method according to claim 11, wherein an attenuation of a luminance, in a ratio to a difference from the first distance (23.1) between the gated camera (5) and the visible object region (19) and the second distance (23.2) between the gated camera (5) and the visible object region (19), is used as the at least one criterion.

15. The method according to claim 14, wherein via the attenuation of the luminance and a pre-determined threshold luminance, the viewing range (31) of the gated camera (5) is calculated.

16. The method according to claim 11, wherein on a basis of the viewing range (31) of the gated camera (5), a maximum speed (35) for a motor vehicle (1) having the gated camera (5) is determined.

17. The method according to claim 11, wherein the viewing range (31) of the gated camera (5) is transmitted by a communication device (13).

18. A control device (7) configured to perform the method according to claim 11.

19. A viewing range measurement device (3), comprising:
a gated camera (5) which has a lighting device (9) and an optical sensor (11);
a control device (7) configured to perform the method according to claim 11; and
a communication device (13) which is configured to transmit a viewing range (13) of the gated camera (5).

20. A motor vehicle (1), comprising:
a viewing range measurement device (3), wherein the viewing range measurement device (3) comprises:
a gated camera (5) which has a lighting device (9) and an optical sensor (11);
a control device (7) configured to perform the method according to claim 11; and
a communication device (13) which is configured to transmit a viewing range (13) of the gated camera (5).
